(19) United States
(12) Patent Application Publication
(10) Pub. No.: US 2025/0386981 A1
(43) Pub. Date: Dec. 25, 2025

(54) FOLDABLE SHOWER SYSTEM

(71) Applicant: LATICRETE INTERNATIONAL, INC., BETHANY, CT (US)

(72) Inventors: Ron Nash, Bethany, CT (US); Spencer Maheu, Bethany, CT (US); Dustin Prevete, Bethany, CT (US)

(21) Appl. No.: 19/235,069

(22) Filed: Jun. 11, 2025

Related U.S. Application Data
(60) Provisional application No. 63/662,528, filed on Jun. 21, 2024.

(51) Int. Cl. A47K 3/28; B32B 3/12; B32B 7/04; B32B 27/08; B32B 27/32; B32B 37/04

(52) U.S. Cl. CPC A47K 3/283; B32B 3/12; B32B 7/04; B32B 27/08; B32B 27/32; B32B 37/04; B32B 2250/03; B32B 2250/242; B32B 2262/0253; B32B 2307/7265; B32B 2607/00

(57) ABSTRACT

Foldable shower boards, systems, and methods of forming waterproof foldable shower structures that include an inner core matrix residing between first and second side layers, and one or more folding sections separating the one-piece board into two or more panels. The one or more folding sections comprising a v-notch in the second side layer having angled interior waterproof surface walls comprising a material of the second side layer. The one or more folding sections provide dual folding capabilities enabling inward and outward folding and unfolding of the one-piece foldable board to form the plurality of foldable shower structures. The plurality of waterproof foldable shower structures are secured within a shower area to form the shower assembly.

### BACKGROUND OF THE INVENTION

This invention relates to foldable shower systems for installation in framed shower areas that are capable of receiving facing materials, such as, ceramic tiles.

### 2. DESCRIPTION OF RELATED ART

During installation of drainable floors, such as showers, it is important that the final laid floor be sloped to guide water toward the drain for facilitating shower drainage and reduce the potential for leaks. Common installation techniques include use of hand-laid cement mortar shower bases (i.e., mud beds), or alternatively prefabricated shower pans, both of which are sloped for proper drainage. Once installed, facing materials, such as ceramic tiles, are typically provided over these mud beds or prefabricated shower pans.

While mud beds provide a suitable shower base, they need to be waterproofed after installation and can crack over time, losing their water impermeability. As such, in many instances prefabricated shower pans are a preferred choice. Prefabricated shower pans are commonly fabricated as a pre-molded waterproof solid fiberglass or acrylic base having an aperture for the drain. They may be made as a large unitary body structure having an area designated for a drain outlet and having a consistent slope towards the drain area. Prefabricated shower pan bases are quick and easy to install, as compared to laying mud beds, since they are formed as molded or cast and can have tiles applied directly thereto after installation without the need for waiting on any mud dry times. However, it has been found that large body pans are often burdensome due to their size, making it difficult to handle and install such large pans.

Modular shower systems are another type of pre-molded shower pan system. These types of systems include a number of pre-molded pieces that are positioned and fit together at the installation site. These systems require positioning and interlocking the various pieces together using mating connections along sides thereof. In some instances, the interlocking modular pieces also need to be glued together to ensure a tight connection, however, openings and/or cracks often remain between these interlocking pieces. As such, it has been found that such modular systems are not only burdensome and time consuming in having to locate appropriate interlocking pieces to fit into a desired installation area, they are also undesirably susceptible to having water seep down into openings and/or cracks remaining after assembly. Water that is trapped beneath a shower floor can cause severe water damage and compromise the structural integrity of shower installation and home.

There is a need, therefore, for new shower systems that allow easy and quick assembly while also providing and maintaining waterproofing over time.

### SUMMARY OF THE INVENTION

Bearing in mind the problems and deficiencies of the prior art, it is therefore an object of the present invention to provide a foldable shower system for installation in a framed shower area that allows easy and quick assembly, and is also waterproof.

Another object of the present invention is to provide a foldable shower system that is easily transportable for shipping, handling, and assembly.

In accordance with one or more embodiments, the invention is directed to a foldable shower board comprising a waterproof one-piece board structure comprising an inner core matrix residing between a first side layer and a second side layer, and one or more folding sections separating the one-piece board into two or more panels. The one or more folding sections comprising a v-notch in the second side layer having angled interior waterproof surface walls comprising a material of the second side layer. The one or more folding sections provide dual folding capabilities enabling inward and outward folding and unfolding for providing a waterproof foldable board.

In other embodiments, the invention is directed to a foldable shower system that includes a plurality of waterproof foldable shower structures each made from one or more waterproof foldable boards. Each of the waterproof foldable boards includes an inner core matrix residing between a first side layer and a second side layer, and one or more folding sections separating the waterproof foldable board into two or more panels. The one or more folding sections comprise a v-notch in the second side layer and has angled interior waterproof surface walls comprising a material of the second side layer. These one or more folding sections provide the waterproof foldable board with dual folding capabilities enabling inward and outward folding and unfolding to form the plurality of foldable shower structures. The plurality of waterproof foldable shower structures are secured within a shower area to form the shower assembly.

In other aspects, the invention is directed to methods of forming a waterproof foldable shower structure. The method includes providing a waterproof one-piece foldable board having an inner core matrix residing between a first side layer and a second side layer, and one or more folding sections separating the one-piece foldable board into two or more panels. Each one or more folding sections comprise an angled v-notch having interior waterproof surface walls comprising a material of the second side layer. These one or more folding sections provide dual folding capabilities enabling inward and outward folding and unfolding of the one-piece foldable board. The one-piece foldable board is opened from a folded collapsed state by moving at least one of the two or more panels in a direction away from the other two or more panels. In so doing, the one or more folding sections transition the one-piece foldable board into an unfolded state to form a waterproof foldable shower structure.

### BRIEF DESCRIPTION OF THE DRAWINGS

The features of the invention believed to be novel and the elements characteristic of the invention are set forth with particularity in the appended claims. The figures are for illustration purposes only and are not drawn to scale. The invention itself, however, both as to organization and method of operation, may best be understood by reference to the detailed description which follows taken in conjunction with the accompanying drawings in which:

FIGS. 1A-1C depict foldable boards in accordance with one or more embodiments of the invention.

FIG. 2A depicts a panel of the foldable boards of FIGS. 1A-1C showing the foldable boards of the invention having an internal matrix residing between a first side and a second side.

FIGS. 2B and 2C depict alternate embodiment side views of FIG. 2A showing an internal matrix residing between one or more layers on both the first and second sides of the foldable boards of the invention.

FIG. 3 depicts a prior art shower board.

FIG. 4 depicts foldable boards of the invention suitable for use in building shower walls or shower wall corners.

FIG. 5 depicts the foldable boards of FIG. 4 in a folded, collapsed state for storage and shipment prior to use and installation.

FIG. 6 depicts a flat shower wall made from the foldable boards in accordance with one or more embodiments of the invention.

FIG. 7 depicts the flat shower wall of FIG. 6 attached to wall studs.

FIGS. 8A-8D depict a foldable shower niche made from the foldable boards in accordance with one or more embodiments of the invention.

FIG. 9 depicts a foldable shower curb made from the present foldable boards in accordance with one or more embodiments of the invention.

FIG. 10 depicts a foldable shower bench made from the present foldable boards in accordance with one or more embodiments of the invention.

FIGS. 11A-11C depict a foldable shower corner seat made from the present foldable boards in accordance with one or more embodiments of the invention.

FIGS. 12A-12D depict foldable shims made from the present foldable boards in accordance with one or more embodiments of the invention.

FIG. 13 depicts a shower assembly including various foldable shower structures made from the present foldable boards in accordance with the invention.

### DESCRIPTION OF EMBODIMENTS OF THE INVENTION

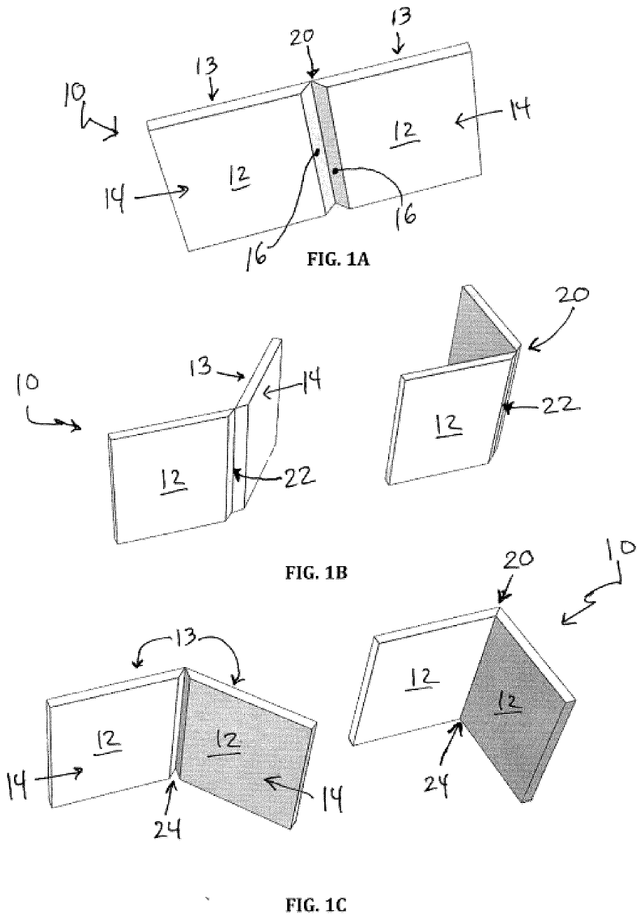

In describing the preferred embodiment of the present invention, reference will be made herein to FIGS. 1A-13 of the drawings in which like numerals refer to like features of the invention.

In accordance with one or more embodiments, the invention is directed to waterproof foldable shower systems for installation in a framed shower area. The present foldable shower systems include a number of different shaped and different sized core boards capable of being folded and unfolded for storage, shipment and use thereof. It should be appreciated that the term foldable in connection with the foldable shower boards of the invention refers to such boards as capable of being both folded and unfolded. For instance, it may be desirable to have the instant foldable shower boards in a folded state for shipping and/or storage, while in installation and use the foldable shower boards reside in an unfolded state. It should also be appreciated that the foldable shower boards may reside in a flat, unfolded state for flat shipment and/or storage, as well as installation use in a flat state. That is, the foldable shower boards of the invention may reside in folded states, partially folded states, or flat states.

Referring to FIGS. 1A-1C, foldable core boards 10 (hereinafter “foldable boards 10”) of the invention are shown having a first side 13 and a second side 14, with at least one folding section 20 residing at the second side 14. Folding section 20 separates the foldable board 10 into individual panels 12. While FIGS. 1A-1C show a single folding section 20 and dual panels 12 of the foldable board 10, it should be appreciated that each individual foldable board of the invention may have multiple folding sections 20 and multiple panels 12.

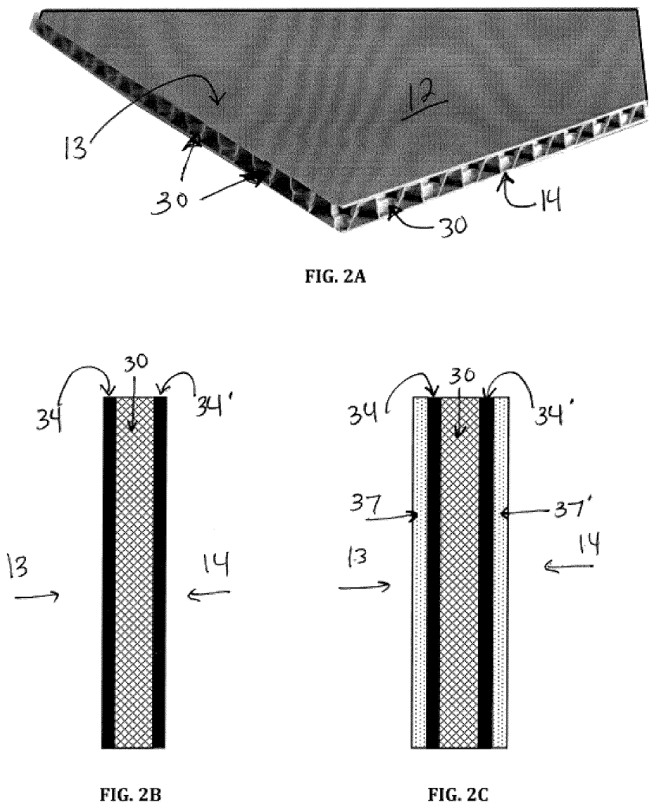

As shown in FIGS. 2A-2B, the foldable boards 10 of the invention may be a multi-layer structure having a planar surface layer 34, 34′ on each of the first and second sides 13, 14 separated from each other by an inner core matrix 30 that provides mechanical integrity and strength to the foldable board. For instance, while not meant to be limiting, the inner core matrix may be a honeycomb-like structure residing throughout the entire board and between layers 34, 34′ at first side 13 and second side 14, respectively. FIG. 2B depicts a representative inner core matrix 30 which may include any configuration and/or structures (including additional layering between layers 34, 34′) that provide the foldable board 10 with sufficient strength and integrity for use in installation in a framed shower area.

Referring again to FIG. 1A, the folding section 20 of the present foldable boards 10 have an angled configuration with angles extending down from planar layer 34′ of second side 14 of each panel 12. In one or more embodiments, the folding section 20 comprises a v-notch (i.e., a v-shaped indentation or gap) forming from the angles of each panel 12. The angles of folding section 20 may be formed during fabrication of the foldable board itself, or alternatively, may be cut into a planar board used to fabricate the present foldable boards 10. In one or more embodiments, the folding section 20 may include angled interior waterproofing surface walls 16 comprising a rigid material, such as, the material of layer 34′. Alternatively, the angled interior surface walls 16 of folding section 20 may comprise the inner core matrix 30 of the foldable board 10.

The folding section 20 provides dual folding capabilities allowing both outward folding 22 of the board 10, and inward folding 24 of the board 10. Referring to FIG. 1B, the outward folding 22 capabilities of folding section 20 allows the panels 12 to fold outward, with respect to second side 14. That is, the second side 14 of adjacent panels 12 connected to each other by a folding section 20 move in an outward direction away from each other. In so doing, adjacent first side 13 panels 12 fold towards each other collapsing onto each other at the first side 13 to provide the board 10 in a folded state. This provides a compacted foldable board 10 having panels 12 laying on top of each other so that the board is ready for shipping and/or storage, as well as being easier to handle and maneuver due to its compact, folded size.

Referring to FIG. 1C, the inward folding 24 capabilities of folding section 20 allows the panels 12 to fold inward, with respect to second side 14, to form an angle at folding section 20 with adjacent panels 12 on the second side 14. That is, adjacent panels 12 fold inward towards each other at second side 14 until the angled interior waterproofing surface walls 16 of folding section 20 have a desired distance therebetween to form the desired angle at second surface 14. For instance, the panels 12 may move inwards towards each other and stop once a desired angle is reached whereby adjacent angled interior surface walls 16 do not contact each other. Alternatively, panels 12 may move inwards and stop once the adjacent angled interior surface walls 16 contact each other resulting in the desired angle of the foldable board 10. For instance, while not meant to be limiting, each angled interior surface wall 16 of folding section 20 may have a 45-degree angle, such that, when two (2) adjacent 45-degree angle interior surface walls 16 fold towards each other and contact one another, the adjacent panels 12 of these respective adjacent 45-degree angle interior surface walls 16 form a 90-degree angle with each other (see, e.g., FIG. 1C). The folding inward provides the foldable board 10 in an unfolded state ready for use in installation.

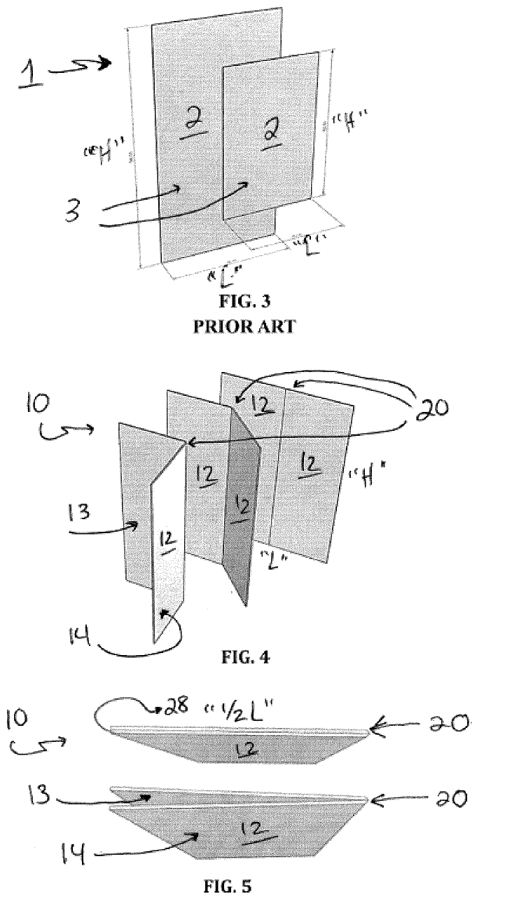

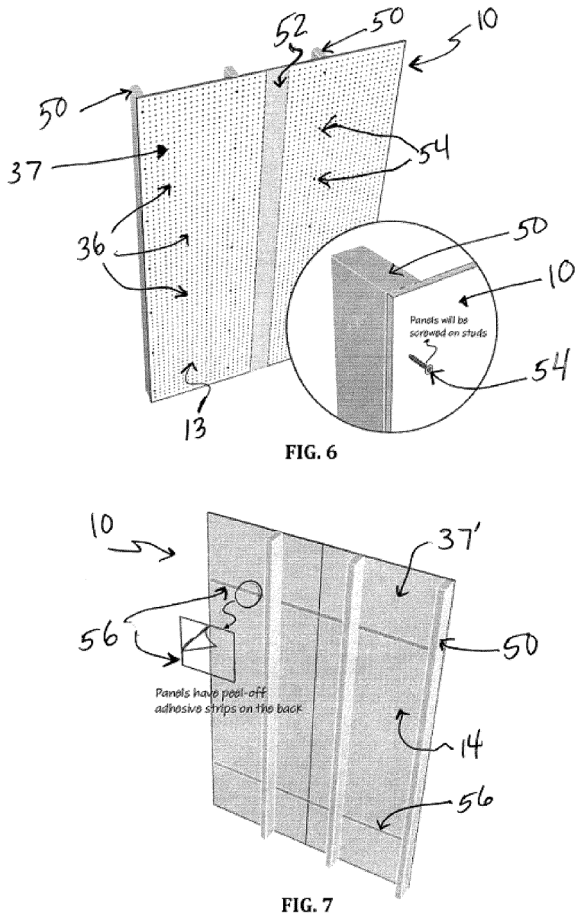

As shown in FIG. 3, a conventional prior art shower board 1 is shown comprising a single panel 2 having a height “H” and length “L”, as measured at a first side 3, that does not change during use and/or storage. Conventional flat boards 1 come in a variety of sizes such as, for instance, dimensions of 3 feet by 5 feet (3′×5′) or 4 feet by 8 feet (4′×8′). The larger dimension flat boards 1 are typically hard to store, ship, handle and use during installation. In overcoming at least these issues, FIGS. 4 and 5 show the foldability and compacting capabilities of the present foldable boards 10. As shown, the present foldable boards 10 fold inwards at a first side 13 so that adjacent panels 12 collapse onto each other to reduce the overall size of the board 10. While the drawings are shown having the folding section 20 running along the height “H” of the foldable board 10 to reduce the length “L” of such board 10 when folded, it should be appreciated that the folding section 20 may also reside along the length “L” of the foldable board 10 to reduce the height “H” thereof when folded. Further, while FIGS. 4 and 5 show the foldable board 10 having a single folding section 20, to reduce either the length “L” or height “H” of the board in half depending on the direction and/or location where the single folding section 20 resides, other embodiments of the invention include multiple folding sections 20 across the foldable board 10, along either the either length “L” and/or height “H”, to make multiple folds in such board 10. Referring to FIG. 5, prior to use in installation, at least one of the panels 12 of the folded board 10 is moved in an upward direction 28 to unfold and open the board 10 providing the panels 12 and the overall board 10 in a flat state (see, e.g., FIGS. 6 and 7). The panel 12 may continue to be unfold by inwardly folding 24 such panel until the desired angle of adjacent panels 12 is obtained (see, e.g., FIG. 1C).

In accordance with one or more embodiments, once unfolded, the foldable boards 10 of the invention may be provided in an unfolded, flat state with adjacent panels 12 being planar with one another as shown in FIG. 6. In these embodiments, at least the first side 13 of the board 10 may include a marking pattern matrix 36 at set measurements residing across the exposed side at the first side (e.g., printed gridlines or dotted markings in parallel rows and columns). In one or more embodiments, both the first side 13 and the second side 14 of the foldable board 10 each include a marking pattern matrix 36 at set intervals or spacing. These marking pattern matrix/matrices 36 are used during installation of the board 10 to a stud 50 for easy alignment and attachment of the board to the stud, as well as to save installation time.

Again, the present foldable boards 10 may comprise a multilayer board having one or more folding sections 20 either alone the length, height, or both the length and height for folding the board 10. The multiple layers of the foldable boards 10 render a rigid, stable, waterproof and vapor-tight resultant board 10. In one or more embodiments, the outer planar surface layers 34, 34′ and inner core matrix 30 may be made of a thermoplastic polymer that is durable and resistant to heat and moisture. For instance, the outer planar surface layers 34, 34′ and inner core matrix 30 may each comprise polypropylene layers heat bonded together. The inner core matrix polypropylene 30 may have any configuration that provides the board with strength, durability, and reliability. While not meant to be limiting, in one or more embodiments the inner core matrix polypropylene 30 may have any geometric configuration such as a honeycomb matrix, rows and columns of three-dimensional geometric shapes, scattered three-dimensional geometric shapes between the outer layers 34, 34′, and the like.

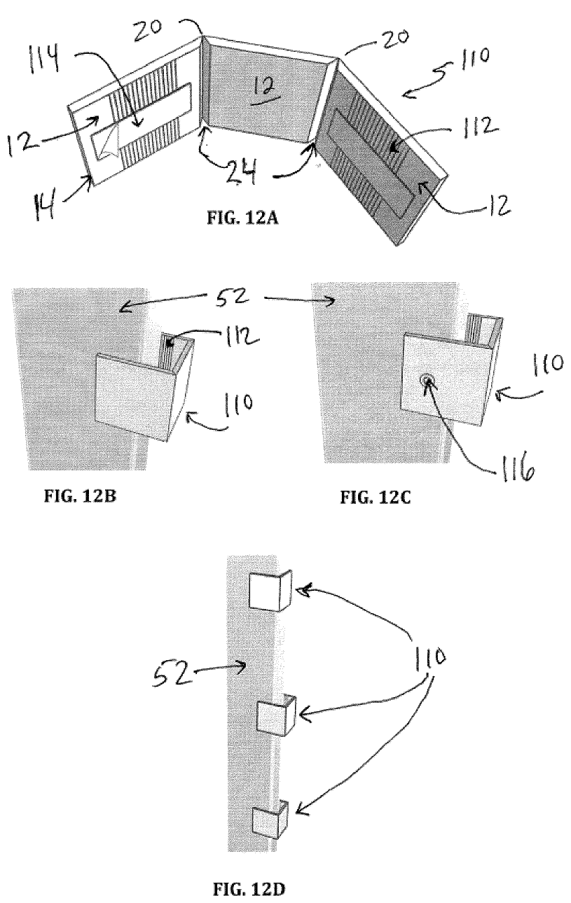

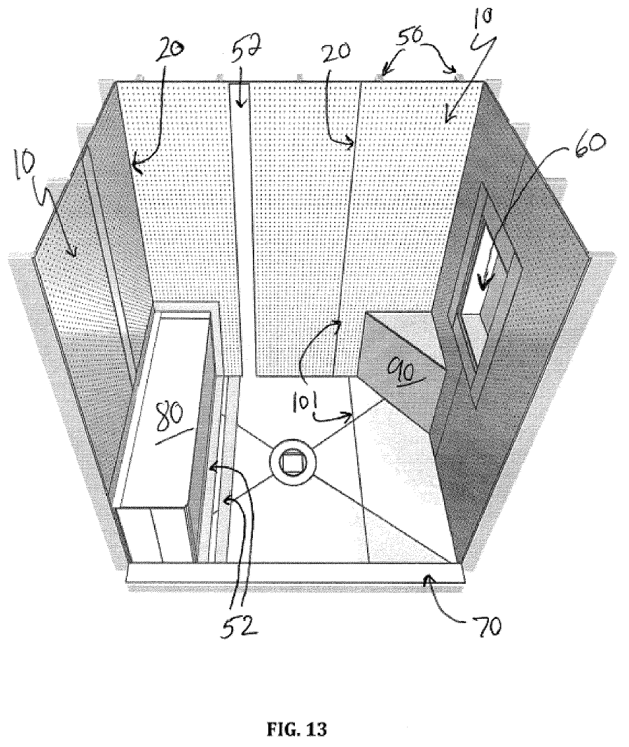

In certain embodiments, a waterproof non-woven fabric material layer 37, 37′ may be provided on surface layer 34 at the first side 13 and/or on surface layer 34′ at the second side 14 of the foldable board 10. The non-woven fabric material layer 37, 37′ on the first 13 and second 14 sides may be a fleece webbing that ensures secure anchoring of thin-set mortar to a board 10 that is anchored to stud(s) 50. The non-woven fabric material layer 37 may reside at least on the first side 13, and in one or more preferred embodiments, also reside on the second side 14. Likewise, the marking pattern matrix 36 may be provided at least on the exposed surface area of the fabric layer 37 at first side 13 (see, FIG. 6), and in one or more preferred embodiments, the marking pattern matrix 36 is also provided on the exposed surface area of the fabric layer 37′ at the second side 14 of the board. By providing fabric layers 37 and 37′ each with marking pattern matrices 36, the resultant foldable board 10 is able to use these markings as alignment guides and measurement guides for ease and precision of installation of the board in both flat installation assemblies (see, e.g., FIGS. 6 and 7), as well as angled installation assemblies (see, e.g., FIGS. 1C and 12).

In accordance with the various embodiments of the invention, the resultant waterproof foldable boards 10 of the invention may include in sequential order from the first side 13 to the second side 14: a first fabric layer 37 secured to a first surface layer 34, an inner core matrix 30, a second surface layer 34′, and a second fabric layer 37′. The inner core matrix 30 is bonded or otherwise attached/secured to the first surface layer 34 and the second surface layer 34′. In certain embodiments the first fabric layer 37 has printed marking pattern matrix 36 on the outer surface thereof. In other embodiments, printed marking pattern matrices 36, 36′ reside on both the first and second fabric layers 37, 37′, respectively. The inner core matrix 40 and first and second surface layers 34, 34′ may comprise a thermoplastic polymer material (e.g., polypropylene), while the first and second fabric layers 37, 37′ may comprise a waterproof non-woven fleece material. It should be appreciated that the other materials known in fabricating shower boards are also suitable for use in the invention and included herein. For instance, the inner core matrix 40 and/or first and second surface layers 34, 34′ may comprise a plastic material, a recycled plastic material (e.g., a Post-Consumer Recycled (PCR) material, such as, recycled PET, HDPE, and/or PP), or a partially recycled plastic material (e.g., a 66% PCR material). In addition to these layers, other embodiments of the invention may include one or more additional layers attached to the first side 13 or the second side 14 of the board. These layers may include, but are not limited to, an additional waterproofing material layer, a sound dampening material layer, an insulating material layer, an antifungal material layer, a material layer having disinfectant properties, peel and stick layer, an uncoupling layer, as well as any combination of two or more of the foregoing layers.

Referring to FIGS. 6 and 7, the present foldable boards 10 may be secured to a frame, such as, stud framing 50. The marking pattern matrix 36 on the fabric layer 37, and/or fabric layer 37′, are used to easily and quickly align the board 10 for attachment to one or more studs 50. The studs may be wood studs or metal studs. The first fabric layer 37 at the board front side 13 may also be provided with a number of space apart guide marks 54 identifying where screws or nails are to be inserted into and through board 10 and into stud 50. The guide marks 54 may be printed on the board 10 in any desired incremental measure (e.g., every 12 inches apart). While the boards 10 may be secured to the studs 50 via nails/screws, in one or more embodiments the second side 14 of the board may have one or more peel and stick adhesive layers or strips 56 for securing the board 10 to the framing (e.g., stud framing). While FIG. 7 shows the adhesive layers/strips 56 residing along the length “L” of the board (which may also be viewed as the width of board 10), these peel and stick adhesive layers/strips 56 may reside at any area or portion of the board 10 to enable securing the board 10 to a substrate (e.g., stud 50, concrete, wall, etc.).

After the board 10 has been attached to a substate, for instance studs 50, the one or more folding sections 20 residing on the board 10 may be sealed with a strip of sealing tape 52 to secure such folding sections 20 as well as protect them from water, moisture and/or vapor damage (see, FIG. 6). For instance, a thin layer of modified thin-set mortar may be applied to all folding sections 20 residing on the installed board(s) 10, followed by pressing a sealing tape over and into the thin-set while removing any air pockets to provide a smooth waterproofed seam. The resultant installed foldable boards 10 of the invention provide installation surface areas that are waterproof, vapor tight, resistant to high temperatures, durable, and dimensionally stable for application of tile and other surface materials. The present lightweight waterproof foldable boards 10 are suitable for use in areas exposed to moisture including, but not limited to, bathrooms, showers, saunas, steam rooms, wet rooms, pool areas, and the like.

As compared to known non-foldable boards, the instant foldable boards 10 are easy to handle, ship and store in their folded state, as well as being quick and easy to maneuver and install, even in tight spaces due to their folding capabilities. The foldable boards 10 of the invention have pre-formed folding section(s) 20 with angled configurations thereby avoiding the need to cut into conventional flat boards to try to bend such known boards. On the contrary, the invention saves time and resources by prefabricating folding sections 20 into a board to provide a foldable board having multiple panels with adjacent panels 12 connected by one or more folding sections 20. Further, in embodiments having rigid waterproofing material interior surface walls 16 covering the angled regions of panels 12 in the v-notch folding section(s) 20, such rigid interior walls 16 provide folding sections 20 with increased strength and durability in both folded and unfolded states (whether in a flat board 10 configuration, or a board 10 install having angled configurations of boards 10), as compared to the mere cutting of a shower board which would decrease the strength and durability of such cut board. The folding sections 20 of the instant foldable boards 10 provide joints or regions on the board that are easy to fold and unfold, while maintaining joint and board integrity.

The foldable boards 10 of the invention are suitable for use in building a variety of different features or products for forming shower assemblies. In one or more embodiments, the present foldable boards 10 may come in individual pieces of boards 10 having one or more panels 12 separated by folding sections 20. In other embodiments, foldable boards 10 of the invention are prefabricated into a desired structure or configuration for forming features within a shower assembly. For instance, the foldable boards 10 are suitable for use in fabricating structures having shapes including, but not limited to, square, rectangular, triangular, convex shapes, and the like.

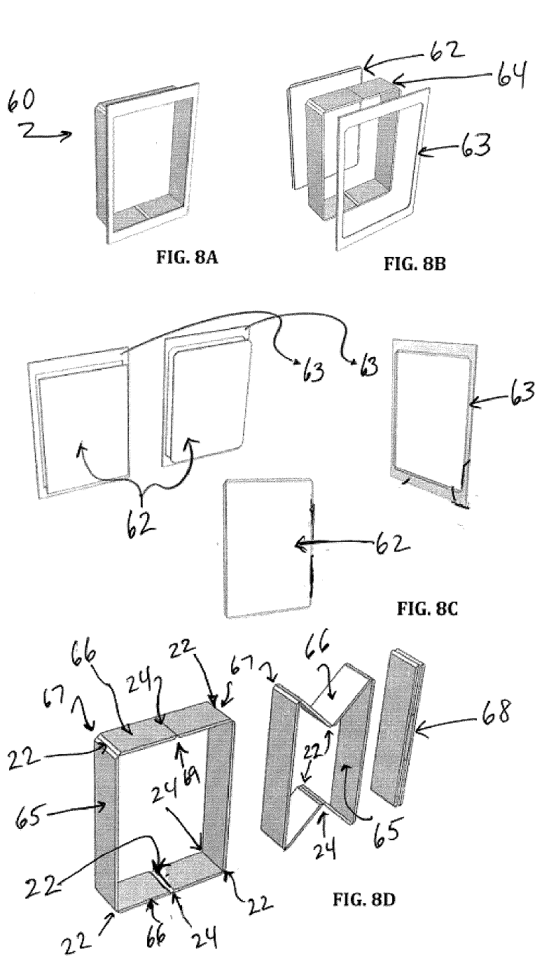

Referring to FIGS. 8A-8D, the present foldable boards 10 may be used to fabricate a shower niche 60. For instance, in forming a shower niche 60, boards 10 of the invention may include a back side planar layer 62, a foldable shower niche frame body 64 comprising the present foldable boards 10, and a front cut out frame layer 63. The foldable shower niche frame body 64 comprises a board 10 that has multiple panels and multiple folding sections 20 configured into a square or rectangular shape. The frame body 64 includes a first set of parallel sidewall panels 65 and a second set of parallel sidewall panels 66. The parallel sidewall panels 65 and 66 are connected to each other via four (4) folding sections 20 residing at corners of the frame body 64. These folding sections 20 at corners of the frame body 64 have the inward fold 24 of side 14 residing inside the frame 64 to form right angles between an adjacent sidewall panel 65 and sidewall panel 66. At least one of the first set of parallel sidewall panels 65 or the second set of parallel sidewall panels 66 have reverse folding sections 69 at the midsection of each panel. For instance, as shown in FIG. 8D, each sidewall panel 66 includes a reverse folding section 69 at its midsection 69. This midsection reverse folding section 69 in panels 66 resides opposite to those of corner sections. That is, the first side 13 resides at the outside of frame 64, such that, folding section 69 has the inward fold 24 at the exterior of the frame 64 and the outward fold 22 at the interior of the frame 64. This enables the inward fold 24 to move inward towards a center of the frame 64 for allowing the frame body 64 to fold inward into a folded shower niche 68 state, as shown in the folding pattern images of FIG. 8D.

In fabricating the shower niche 60, the back side planar layer 62 may comprise a single board or multiple boards adhered together. For instance, the back side planar layer 62 may comprise two (2) boards or panels glued together to provide the back of the niche 60 with sufficient strength and rigidity. In certain embodiments, one of the boards/panels used to make the back side planar layer 62 may be smaller in dimensions than the other for forming a frame onto which foldable frame body 64 can be positioned and secured. The front cut out frame layer 63 may comprise a single layer board or multiple boards/panels glued together. For instance, the front cut out frame layer 63 may comprise two (2) 3/16 inch thick boards glued together to match a thickness of a shower board 10 having a ⅜ inch thickness. Both the back side planar layer 62 and the front cut out frame layer 63 may be prefabricated, or alternatively fabricated on the site of installation. The foldable frame body 64 is positioned over and onto the back side planar layer 62 and secured thereto (e.g., glued). The front cut out frame layer 63 is then attached (e.g., glued) to the foldable frame body 64.

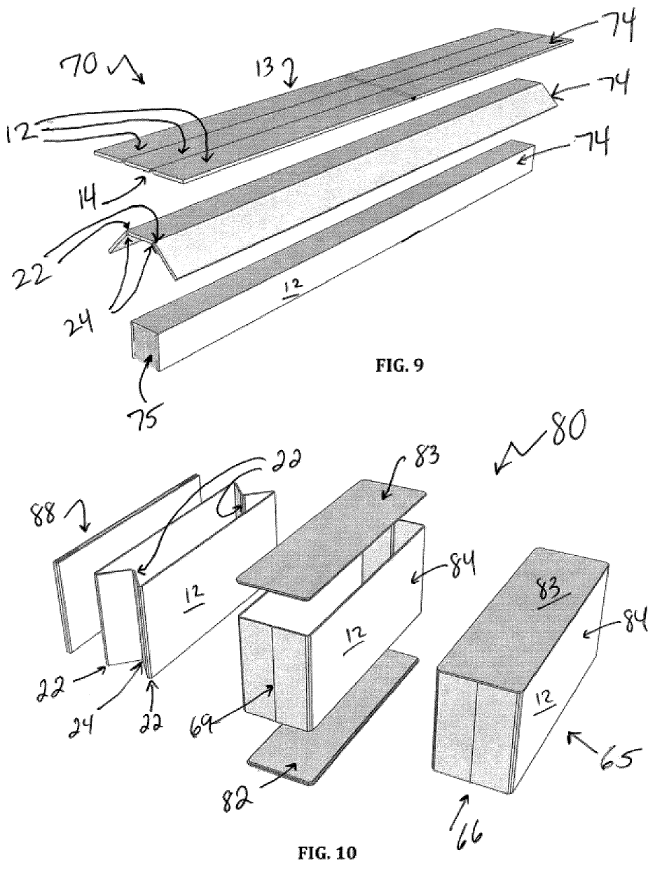

The foldable boards 10 of the invention may also be used to form a shower curb 70. For instance referring to FIG. 9, a shower curb 70 may be formed using a form 75 such as a wood form structure 75 (e.g., a 2×4 wood structure). The foldable boards of the invention are provided as a foldable shower curb body having at least two (2) panels 12 separated from each other by a folding section 20. In other embodiment, the foldable shower curb body 74 may comprise at least three (3) panels 12 with adjacent panels 12 being separated from one another by folding sections 20, as shown in FIG. 9. The foldable shower curb 74 folds in a direction whereby the second side's 14 inward folding 24 sections fold inwards so that the surface layer 34′ at the second side 14 is provided over and contacts the form 75 (e.g., wood form structure). The foldable shower curb 74 is secured to form 75 using one or more of the following: adhesive, glue, screws, nails, and the like. Prior to installation, the foldable shower curb 74 may reside in a folded state via folding sections 20 as described herein.

In other embodiments the present foldable boards 10 may be used to form a shower bench 80, as shown in FIG. 10. For instance, like that of shower niche 60 embodiments of the invention, the shower bench 80 includes a foldable shower bench frame 84 made of the present foldable boards 10. The foldable shower bench frame 84 comprises board 10 that has multiple panels 12 and multiple folding sections 20 configured into a square or rectangular shape. The foldable shower bench frame 84 includes a first set of parallel sidewall panels 65 and a second set of parallel sidewall panels 66 connected to each other via folding sections 20 at corners of bench frame 84. The parallel sidewall panels 65 have reverse folding sections 69 at the midsection thereof. The outward folding 22 and inward folding 24 capabilities of each folding section 20 allows the foldable shower bench frame 84 to fold into a flat, folded bench frame 88 state and unfold into the unfolded state forming the shower bench frame 84. A bench bottom layer 82 and a bench top layer 83 are applied to the bottom and top, respectively, of the formed shower bench frame 84. These bottom and top layers 82, 83 may comprise a single or double layer board that are securely adhered to the bottom and top of bench frame 84 (e.g., using adhesive, glue, screws, nails, etc.).

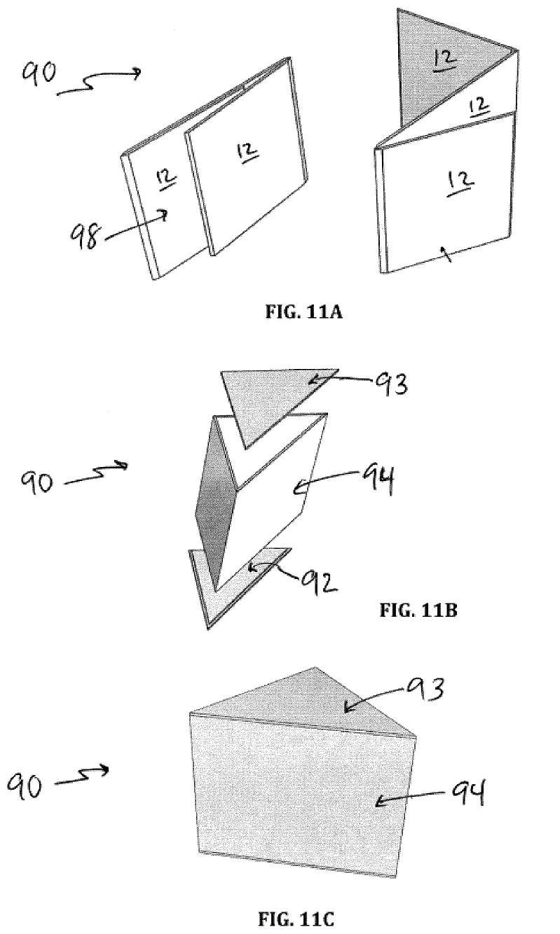

Like that of foldable shower bench frame 84 and shower niche 60, the present foldable boards 10 may be used to form a shower corner seat 90. Referring to FIGS. 11A-C, foldable corner seats 90 of the invention include a corner seat frame 94 comprising panels 12 of the foldable board material separated by folding sections 20. The outward folding 22 and outward folding 24 capabilities enable the present board to being maneuvered from a flat, folded corner seat frame 98 state to an unfolded state that renders the corner seat frame 94 ready for installation. Single or double bottom corner seat 92 and top corner seat 93 layers are secured to the bottom and top of the corner seat frame 94. Again, the bottom and top seat layers 92, 93 may be securely adhered to the corner seat frame 94 using known means as described herein.

Referring to FIGS. 12A-D, the foldable boards 10 may also be used to form foldable shims 110 of the invention. For instance the foldable shims 110 may comprise a foldable board 10 having panels 12 separated from one another by folding sections 20. Referring to FIG. 12A, in one or more embodiments the foldable shim 110 includes three (3) panels 12 with adjacent panels separated from one another by a folding section 20. The second side 14 of the foldable shim 110 may include a number of guide marks 112 which are used to measure placement of the shim 110 during installation. The guide marks 112 may be printed onto the shim 110, or they may be formed into or onto a surface of the second side of the shim. For instance, the second side 14 of shim 110 may have guide marks 112 spaced apart from each other at 1/16 inch increments. Each foldable shim 110 may have a thickness ranging from about 1/16 inch up to 2 inches, and preferably, and ⅛ inch thick.

Also attached to the second side 14 of the foldable shim 110 may be one or more peel and stick adhesive strips 114 for adhering the shim second side 14 to a structure during installation of wall boards or corner boards made from the present foldable boards 10. The foldable shims 110 are used to adjust a depth or distance between a structure made from foldable boards 10 (e.g., wall board or corner wall) and a stud (or other structure) to which such foldable boards 10 are being attached to for providing an even flat finish. That is, in the event one or more studs (or other structure to which boards 10 are being attached to) is not in straight alignment with other studs, the foldable shims 110 may be used to even out such alignment and enable the foldable boards 10 of the invention to be installed in straight alignment. Referring to FIGS. 12B and 12C, guide marks 112 are used to determine a length or amount of each outer panel 12 of the shim 110 that is to be attached to the stud 52 for providing straight alignment of wall boards made from foldable boards 10. The peel and stick adhesive strips 114 and/or one or more screws or nails inserted into attachment marks 116 on shim may be used to secure the shim 110 to the stud 52. A number of foldable shims 110 of the invention may be attached to a single stud 52, as shown in FIG. 12D.

A resultant shower assembly including the various embodiments of the present foldable boards 10 is shown in FIG. 13. As shown, the shower assembly includes foldable boards of the invention used to form flat planar walls, wall corners, shower niches 60, shower curbs 70, shower benches 80, shower corner seats 90, and shims 110. A waterproofing sealing tape 52 may be used to seal seams at folding sections 20, as well as at locations where the various structures of the invention meet flooring and/or walls of the shower. In addition to waterproofing sealing tape 52, or in the alternative thereto, waterproofing adhesives and/or sealants 101 may applied to folding sections 20 or other open seams within the shower assembly. Again, for ease of installation the non-woven fabric material layers 37, 37′ on the outer surfaces of the present foldable boards are provided with marking pattern matrices 36 at set intervals apart (e.g., a 1-inch dot printed matrix) which are used for easy alignment and attachment of the boards 10 to a stud 50.

Prior to use, the various embodiments or waterproof structures of the invention made from waterproof foldable boards 10 are stored and shipped in a flat state making for efficient transportation and storage. Again, structures formed using the foldable boards 10 may include, but are not limited to, a flat wall, wall corner, niche, curb, bench, corner seat, shims, and the like, whereby all structures of the invention are collapsible onto itself to render a folded state of such structure. When ready to use, the flat foldable board structures open-up or pop-open to an unfolded state ready for use in making the various structures or products of the invention. The foldable board structures of the invention may be installed or adhered to studs, wall board, foam (e.g., foam shower tray), sheet membranes, waterproof membranes, cement, mortar bed, and the like. The foldable boards 10 and various structures made from such boards may be adhered to surfaces using one or more of the following including, but not limited to, adhesives, glues, sealant, thin set with seam tape, peel and stick adhesive materials (e.g. peel and stick adhesive strips, or peel and stick adhesive seam tape), screws, nails, galvanized nails or screws, and the like. Once installed, the waterproof folding sections 20 result in a structure having waterproof seams that do not require additional seam treatment when banding boards together with adhesive, sealant, thin-set, and/or seam tape.

While the present invention has been particularly described, in conjunction with a specific preferred embodiment, it is evident that many alternatives, modifications and variations will be apparent to those skilled in the art in light of the foregoing description. It is therefore contemplated that the description will embrace any such alternatives, modifications and variations as falling within the true scope and spirit of the present invention.

1. A foldable shower board comprising:
a waterproof one-piece board structure comprising an inner core matrix residing between a first side layer and a second side layer;
one or more folding sections separating the one-piece board into two or more panels, the one or more folding sections comprising a v-notch in the second side layer having angled interior waterproof surface walls comprising a material of the second side layer, the one or more folding sections providing dual folding capabilities enabling inward and outward folding and unfolding to provide a waterproof foldable board.

2. The board of claim 1 wherein the inner core matrix, the first side layer, the second side layer, and the angled interior waterproof surface walls of the v-notch all comprise a durable thermoplastic polymer material.

3. The board of claim 2 wherein the durable thermoplastic polymer material comprises polypropylene, whereby the inner core matrix, the first side layer, the second side layer and the angled interior waterproof surface walls of the v-notch all comprising polypropylene are heat bonded together.

4. The board of claim 1 wherein at least one of more of the inner core matrix, the first side layer, the second side layer, and the angled interior waterproof surface walls of the v-notch all comprises a recycled plastic material or a partially recycled plastic material.

5. The board of claim 1 wherein the inner core matrix has a geometric configuration that provides the waterproof foldable board with mechanical integrity and strength.

6. The board of claim 5 wherein the geometric configuration of the inner core matrix comprises a honeycomb matrix.

7. The board of claim 1 wherein the one or more folding sections reside along a length of the one-piece board.

8. The board of claim 1 wherein the one or more folding sections reside along a height of the one-piece board.

9. The board of claim 1 wherein further including one or more additional layers attached to one or both the first side layer and the second side layer.

10. The board of claim 9 wherein the one or more additional layers comprises a waterproof non-woven layer having a marking pattern matrix for use as an alignment guide for easy and accurate installation of the waterproof foldable board.

11. The board of claim 1 wherein a single folding section resides at a mid-section of the one-piece board separating the one-piece board into two equal sized panels.

12. The board of claim 11 wherein the single folding section enables the two equal sized panels to fold inwards and collapse onto each other to provide the waterproof foldable board in a folded state.

13. The board of claim 1 wherein two or more folding sections reside equally spaced across the one-piece board to form equally sized three or more panels, with adjacent panels being separated from one another by one of the two or more folding sections.

14. The board of claim 13 wherein the two or more folding sections enable the three or more panels to fold inwards and collapse onto each other to provide the waterproof foldable board in a folded state.

15. The board of claim 13 wherein the two or more folding sections enable the folded waterproof foldable board to inwardly and outwardly unfold to form a waterproof structure comprising the unfolded waterproof foldable board.

16. The board of claim 1 wherein one or more of the waterproof foldable board is used to fabricate a foldable shower structure selected from the group consisting of a foldable shower wall, foldable shower corners, foldable shower niches, foldable shower curbs, foldable shower benches, foldable shower corner seats, and foldable shims.

17. A foldable shower system comprising:
a plurality of waterproof foldable shower structures each made from one or more waterproof foldable boards;
each waterproof foldable board comprising an inner core matrix residing between a first side layer and a second side layer, and one or more folding sections separating the waterproof foldable board into two or more panels, wherein each one or more folding sections comprises a v-notch in the second side layer and has angled interior waterproof surface walls comprising a material of the second side layer, the one or more folding sections providing the waterproof foldable board with dual folding capabilities enabling inward and outward folding and unfolding for forming the plurality of foldable shower structures; and
the plurality of waterproof foldable shower structures secured within a shower area to form the shower assembly.

18. A method of forming a waterproof foldable shower structure comprising:
providing a waterproof one-piece foldable board having an inner core matrix residing between a first side layer and a second side layer, and one or more folding sections separating the one-piece foldable board into two or more panels with each one or more folding sections comprising an angled v-notch having interior waterproof surface walls comprising a material of the second side layer, whereby the one or more folding sections provide dual folding capabilities enabling inward and outward folding and unfolding of the one-piece foldable board;
opening the one-piece foldable board from a folded collapsed state by moving at least one of the two or more panels in a direction away from the other two or more panels, whereby the one or more folding sections transition the one-piece foldable board into an unfolded state for forming a waterproof foldable shower structure.

19. The method of claim 18 wherein the waterproof foldable shower structure is selected from the group consisting of a foldable shower wall, foldable shower corners, foldable shower niches, foldable shower curbs, foldable shower benches, foldable shower corner seats, and foldable shims.

20. The method of claim 18 further including providing a plurality of waterproof one-piece foldable boards and forming a plurality of waterproof foldable shower structures, the method further including the step of securing the plurality of waterproof foldable shower structures in a shower area to form a shower assembly.
